(19) United States
(12) Patent Application Publication
(10) Pub. No.: US 2026/0240701 A1
(43) Pub. Date: Aug. 20, 2026

(54) ROTATING PUSH HANDLE GRIPS FOR PATIENT SUPPORT APPARATUS

(71) Applicant: Hill-Rom Services, Inc., Batesville, IN (US)

(72) Inventors: Andrew DOLE, Batesville, IN (US); Brian GUTHRIE, Greensburg, IN (US); Robert Mark ZERHUSEN, Cincinnati, OH (US)

(21) Appl. No.: 19/538,652

(22) Filed: Feb. 12, 2026

Related U.S. Application Data
(60) Provisional application No. 63/758,551, filed on Feb. 14, 2025.

(51) Int. Cl. A61G 7/05

(52) U.S. Cl. CPC A61G 7/0528

(57) ABSTRACT

The present disclosure relates to the use of systems and methods that improve maneuverability of patient support apparatus. More specifically, the present disclosure relates to patient support apparatus with push handles comprising a gripping portion and a handle tube, wherein the handle tube is attached to the upper frame and configured to include a first angled portion and a second vertical portion, and wherein the gripping portion is configured to be rotatable about a first axis parallel to the first angled portion of the handle tube.

### CROSS-REFERENCE TO RELATED APPLICATIONS

This nonprovisional applications claims the benefit and priority, under 35 U.S.C. § 119(e) and any other applicable laws or statues, to U.S. Provisional Patent Application Ser. No. 63/758,551 filed on Feb. 14, 2025, the entire disclosure of which is hereby expressly incorporated herein by reference

### BACKGROUND

The present disclosure relates to the use of systems and methods to improve patient care by optimizing use and efficiency of patient support apparatus. More specifically, the present disclosure is related to systems and methods that improve maneuverability of patient support apparatus.

The present disclosure relates to patient support apparatuses, such as hospital beds or stretchers, and particularly to patient support apparatuses having powered transport devices such as motorized wheels or motorized traction drives to propel the patient support apparatus along a floor.

A patient support apparatus may comprise a frame, a patient support coupled to the frame, a push handle coupled to the frame and having a handle post, and a user interface coupled to the handle post and having at least one user input. The user interface may be rotatable about an axis defined by the handle post between a first position presenting the at least one user input to a caregiver standing at an end of the frame and a second position presenting the at least one user input to a caregiver standing alongside the frame.

When a patient support apparatus is moved around a hospital a lot of maneuvering may be required. To turn the patient support apparatus, a transporter may use the push handles coupled to the frame of the patient support apparatus. When the push handles are used to maneuver the patient support apparatus, the grip on the push may cause friction and heat, thereby harming the transporter.

This disclosure relates to push handles coupled to the frame of patient support apparatuses. Specifically, this disclosure relates to apparatuses with push handles that are positioned at angles that increase maneuverability. This disclosure also relates to apparatuses with push handles that comprise rotatable grips. This disclosure relates to devices that can reduce friction and heat production, thereby minimizing harm to transporters.

### SUMMARY

The present disclosure includes one or more of the features recited in the appended claims and/or the following features which, alone or in any combination, may comprise patentable subject matter.

According to a first aspect, the present disclosure is directed to a patient support apparatus comprising a patient support deck positioned on an upper frame and including a head deck section, a seat deck section, and a foot deck section supported on the upper frame, a plurality of casters connected with a lower frame, and a plurality of push handles coupled to the head deck section, each of the push handles comprising a gripping portion and a handle tube, wherein the handle tube is configured to include a first angled portion and a second vertical portion, and wherein the gripping portion is configured to be rotatable about a first axis parallel to the first angled portion of the handle tube. The handle tube is attached to the upper frame or the lower frame.

In some embodiments of the first aspect, the gripping portion may be positioned at an angle of about 5 degrees to 40 degrees relative to a second axis parallel to the second vertical portion of the handle tube.

In some embodiments of the first aspect, the gripping portion may be fastened to the handle tube with an adjustable knob.

In some embodiments of the first aspect, the gripping portion may be configured to be lockable to the handle tube with the adjustable knob, and the gripping portion may not be rotated about the first axis when locked.

In some embodiments of the first aspect, the adjustable knob may be configured to control rotation of the gripping portion about the first axis.

In some embodiments of the first aspect, the gripping portion may be configured to be rotatable 360 degrees about the first axis.

In some embodiments of the first aspect, the second vertical portion of the handle tube may be attached to the upper frame by an insert attachment.

In some embodiments of the first aspect, the gripping portion of a first push handle may be configured to be rotatable in the same direction as the gripping portion of a second push handle.

In some embodiments of the first aspect, the gripping portion of a first push handle may be configured to be rotatable in a different direction than the gripping portion of a second push handle.

In some embodiments of the first aspect, handle tube may further comprise a third portion.

In some embodiments of the first aspect, the third portion of the handle tube may be a third angled portion positioned in between the first angled portion and the second vertical portion.

According to a second aspect, the present disclosure is directed to a method of moving a patient support apparatus comprising applying a torque on a gripping portion of a push handle located on the patient support apparatus, and transferring the torque applied on the push handle to an insert attachment configured to engage with an upper frame of the patient support apparatus. The push handle is configured to comprise the gripping portion and a handle tube. The gripping portion is configured to be rotatable about an axis parallel to a first angled portion of the handle tube.

In some embodiments of the second aspect, the patient support deck may comprise a head deck section, a seat deck section, and a foot deck section supported on an upper frame.

In some embodiments of the second aspect, the gripping portion may be positioned at an angle of about 5 degrees to 40 degrees relative to a second axis parallel to a second vertical portion of the handle tube.

In some embodiments of the second aspect, the handle tube may further comprise a third portion.

In some embodiments of the second aspect, the third portion of the handle tube may be a third angled portion positioned in between the first angled portion and the second vertical portion.

In some embodiments of the second aspect, the gripping portion may be fastened to the first angled portion with an adjustable knob.

In some embodiments of the second aspect, the method may comprise adjusting the gripping portion by moving an adjustable knob, wherein the gripping portion may be configured to be lockable to the handle tube with the adjustable knob.

In some embodiments of the second aspect, the adjustable knob may be configured to control rotation of the gripping portion about the axis parallel to the first portion of the handle tube.

In some embodiments of the second aspect, the gripping portion may be configured to be rotatable 360 degrees about the axis parallel to the first portion of the handle tube.

In some embodiments of the second aspect, a second vertical portion of the handle tube may be attached to the upper frame by the insert attachment.

In some embodiments of the second aspect, the patient support apparatus may comprise a first and a second push handle, and the gripping portion of the first push handle may be configured to be rotatable in the same direction as the gripping portion of the second push handle.

In some embodiments of the second aspect, the patient support apparatus may comprise a first and a second push handle, and the gripping portion of the first push handle may be configured to be rotatable in a different direction than the gripping portion of the second push handle.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of an embodiment of a patient support apparatus with push handles positioned in an upright position for use by a caregiver;

FIG. 2 is a perspective view of an embodiment of the patient support apparatus with push handles positioned in a storage position;

FIG. 3 is an illustration of a first embodiment of the push handles coupled to the upper frame of the patient support apparatus from as viewed form a head end of the apparatus;

FIG. 4 is an illustration of a second embodiment of the push handles coupled to the upper frame of the patient support apparatus from as viewed form a head end of the apparatus;

FIG. 5 is an illustration of a third embodiment of the push handles coupled to the upper frame of the patient support apparatus from as viewed form a head end of the apparatus;

FIG. 6 is an illustration of the first embodiment of the push handle shown in FIG. 3;

FIG. 7 is an exploded view of the push handle shown in FIG. 6;

FIG. 8 is an illustration of the second embodiment of the push handle shown in FIG. 4;

FIG. 9 is an exploded view of the push handle shown in FIG. 8;

FIG. 10 is an exploded view of one embodiment of the gripping region that is not rotatable about a handle tube; and

FIG. 11 is an exploded view of one embodiment of the gripping region that is rotatable about a handle tube.

### DETAILED DESCRIPTION

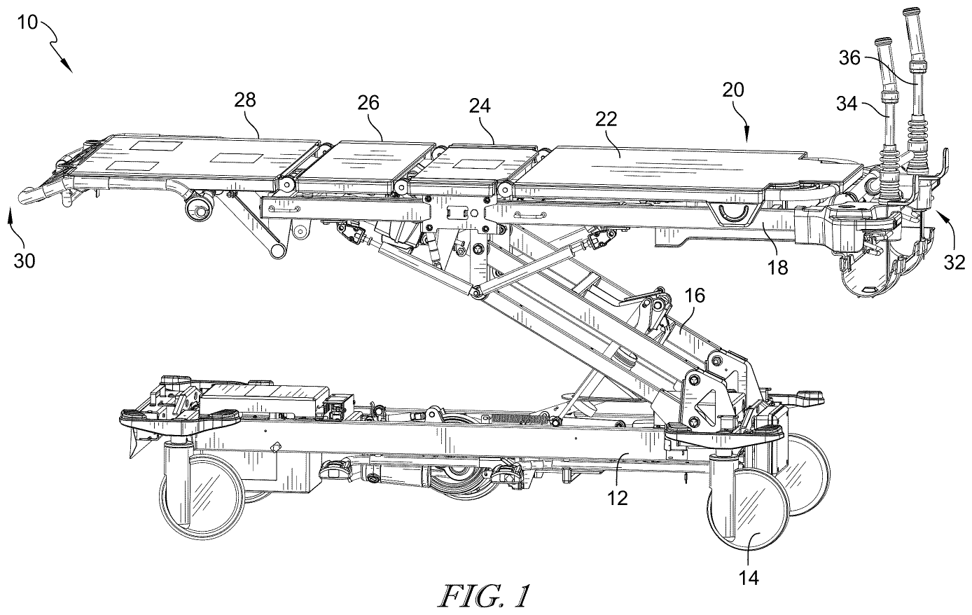

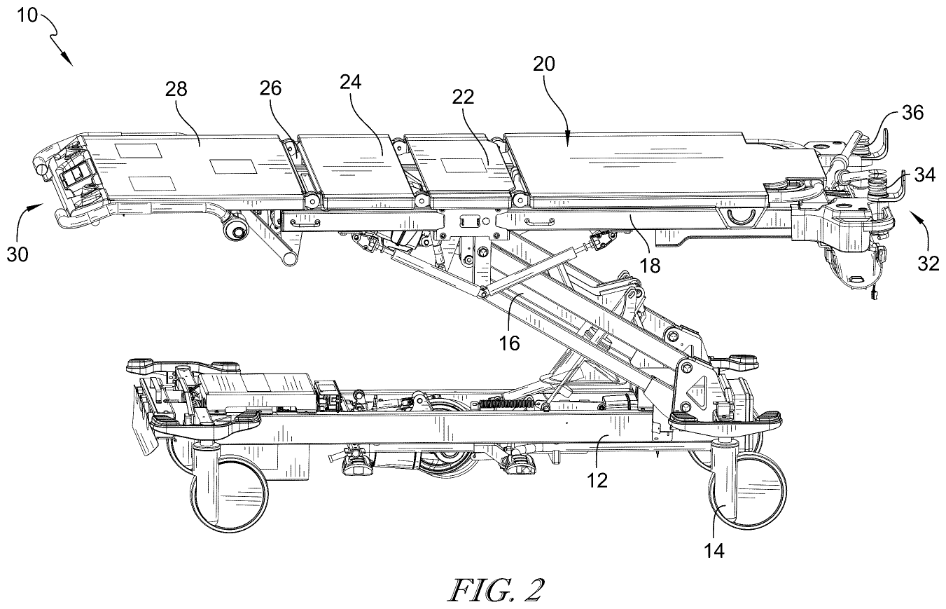

According to the present disclosure, a patient support apparatus, embodied as a stretcher 10 and shown in FIGS. 1 and 2 is configurable to provide care to patients of varying acuity, while also providing improved mobility as a patient is moved between areas of a care facility, such as a hospital, for example. The patient support apparatus 10 includes a lower frame 12 supported on four casters 14 that are lockable to prevent movement of the patient support apparatus 10 over the floor but are oversized to provide smooth movement over the floor when released. The lower frame 12 supports a lift assembly 16 which provides cantilevered support of an upper frame 18 and moves the upper frame 18 vertically when the lift assembly 16 is activated.

The upper frame 18 supports a patient deck 20 that is configured to support a patient mattress. The patient deck 20 has multiple sections and has panels that are constructed of radiolucent material so that a C-arm x-ray device or other similar imaging devices may be used with the patient deck 20. The patient deck 20 has a pivoting head deck section 22 that pivots or moves relative to the upper frame 18. A thigh deck section 24 and a calf deck section 26 are also pivotable relative to the upper frame 18. A foot deck section 28 is supported from the upper frame 18 and pivotable relative to the thigh deck section 24. The foot deck section 28 is configured to move to a dependent position wherein the foot end 30 of foot deck section 28 drops below the upper frame 18 so that the patient deck 20 may form a chair-like arrangement for patient comfort and optimal positioning.

The patient support apparatus 10 may also include an oxygen tank holder that supports an oxygen tank. The patient support apparatus 10 may further include a right-side rail and a left-side rail. The orientation of the sides and ends of the patient support apparatus 10 is established by the orientation of a patient supported on the patient support apparatus 10 in a supine position such that the right-side rail is positioned to the patient's right and the left-side rail is positioned to the patient's left. Similarly, references the foot deck section 28 or foot end 30 related to the position of the patient's feet when in the supine position on the patient support apparatus 10. Likewise, a head end 32 is oriented at the end of the patient support apparatus 10 where a patient's head would be in a supine position.

To assist with the mobility of the patient support apparatus 10, push handles 34, 36 are positioned at the head end 32 of the patient support apparatus 10. The push handles 34, 36 are configured to allow a caregiver to push the patient support apparatus and thereby rotate the casters 14 for transport of the patient support apparatus 10. The push handles 34, 36 in the embodiment of FIGS. 1 and 2 are fixed to the upper frame 18 and the height of the push handles 34, 36 can be adjusted by adjusting the height of the upper frame 18 using the lift assembly 16. The push handles 34, 36 may be fixed to the lower frame 12 or to an endboard at the head end 32 or foot end 30 (e.g., headboard at the head end 32) of the patient support apparatus 10. The push handles 34, 36 may be the mirror images of each other. The push handles 34, 36 may be upright as shown in FIG. 1 or may be folded down in a storage position as shown in FIG. 2. A caregiver has increased access to the patient when the push handles 34, 36 are folded to be in the storage position. Such a configuration that allows the push handles 34, 36 to be folded can improve and prevent inefficiencies patient care.

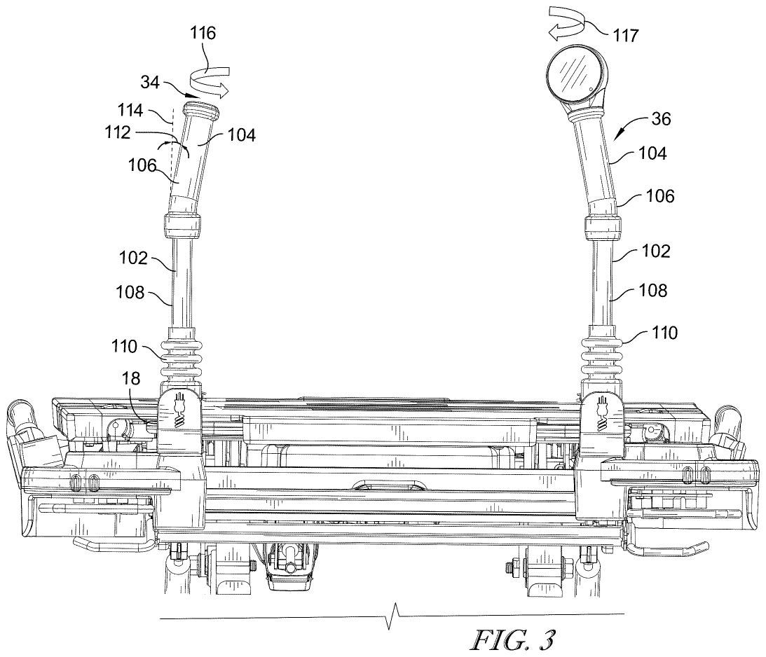

As shown in FIG. 3, each push handle 34, 36 includes a handle tube 102 and a gripping region 104. The handle tube 102 may be hollow structure or a solid structure. The handle tube 102 comprises a generally angled or bent portion 106 and a generally straight portion 108. The generally angled or bent portion 106 is inserted into the gripping region 104. The generally angled or bent portion 106 may be positioned at an angle 112 relative to a vertical axis 114. The angle 112 may range from about 3 degrees to about 40 degrees relative to the vertical axis 114, including any angle or range comprised therein. The angle 112 may range from about 3 degrees to about 5 degrees, about 5 degrees to about 10 degrees, about 10 degrees to about 15 degrees, about 15 degrees to about 20 degrees, about 20 degrees to about 25 degrees, about 25 degrees to about 30 degrees, about 30 degrees to about 35 degrees, or about 35 degrees to about 40 degrees.

The angle 112 increases the ergonomic use of the handles 34, 36. This is particularly useful when the gripping region 104 is more vertical because if the griping region is horizontal a rotating grip does not provide the same benefit of reducing friction and improving the maneuvering of the patient support apparatus 10. In some embodiments, the gripping region 104 is positioned at an angle 112 relative to a vertical axis 114. The generally straight portion 108 of the handle tube 102 is connected to the upper frame 18 by an insert attachment 110.

Each push handle 34, 36 is configured to be rotatable in a direction 116, 117 when force is exerted on the gripping region 104 by a user. In some embodiments, the push handles 34, 36 may be rotatable in the same direction or in different directions. In some embodiments, the push handles 34, 36 may be rotatable in clockwise and/or counterclockwise directions.

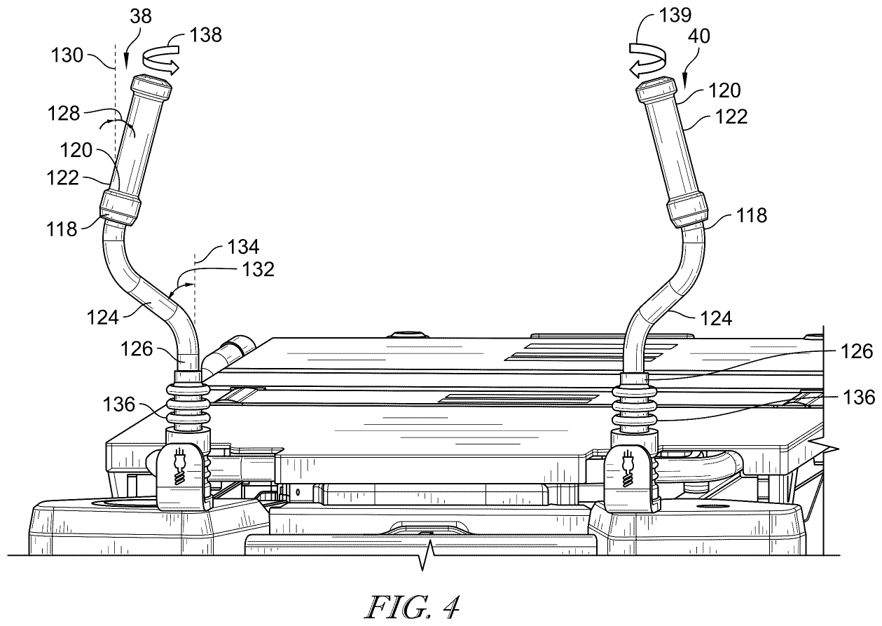

FIG. 4 illustrates another embodiment including push handles 38, 40. Each push handle 38, 40 includes a handle tube 118 and a gripping region 120. The handle tube 118 may be a hollow structure or a solid structure. The handle tube 118 comprises a first generally angled or bent portion 122, a second generally angled or bent portion 124, and a generally straight portion 126. The first generally angled or bent portion 122 is inserted into the gripping region 120. The first generally angled or bent portion 122 may be positioned at an angle 128 relative to a vertical axis 130. The angle 128 may range from about 5 degrees to about 40 degrees relative to the vertical axis 130, including any angle or range comprised therein. The angle 128 may range from about 3 degrees to about 5 degrees, about 5 degrees to about 10 degrees, about 10 degrees to about 15 degrees, about 15 degrees to about 20 degrees, about 20 degrees to about 25 degrees, about 25 degrees to about 30 degrees, about 30 degrees to about 35 degrees, or about 35 degrees to about 40 degrees.

The second generally angled or bent portion 124 may be positioned at an angle 132 relative to a vertical axis 134. The angle 132 may range from about 3 degrees to about 60 degrees relative to the vertical axis 134, including any angle or range comprised therein. In some embodiments, the angle 132 may range from about 3 degrees to about 40 degrees relative to the vertical axis 134, including any angle or range comprised therein. The angle 132 may range from about 3 degrees to about 5 degrees, about 5 degrees to about 10 degrees, about 10 degrees to about 15 degrees, about 15 degrees to about 20 degrees, about 20 degrees to about 25 degrees, about 25 degrees to about 30 degrees, about 30 degrees to about 35 degrees, about 35 degrees to about 40 degrees, about 40 degrees to about 45 degrees, about 45 degrees to about 50 degrees, about 50 degrees to about 55 degrees, or about 55 degrees to about 60 degrees.

The generally straight portion 126 of the handle tube 118 is connected to the upper frame 18 by an insert attachment 136. Each push handle 38, 40 is configured to be rotatable in a direction 138, 139 when force is exerted on the gripping region 120 by a user. In some embodiments, the gripping region 120 is configured to freely rotate all the way around. This is particularly useful when the gripping region 120 is more vertical because if the griping region is horizontal a rotating grip does not provide the same benefit of reducing friction and improving the maneuvering of the patient support apparatus 10. In some embodiments, the gripping region 120 is positioned at an angle 128 relative to a vertical axis 130.

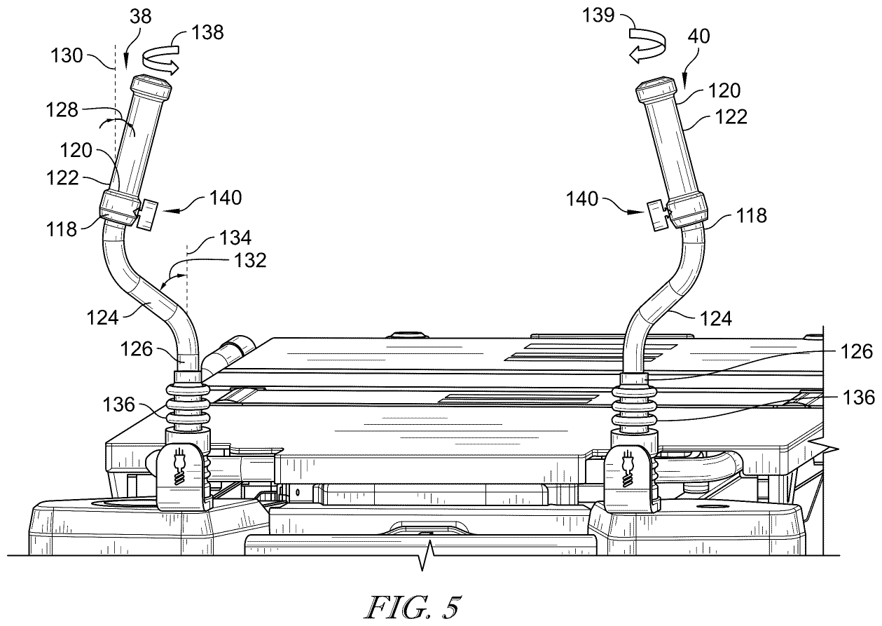

In some embodiments, the push handles 38, 40 may be rotatable in the same direction or in different directions. In some embodiments, the push handles 38, 40 may be rotatable in clockwise and/or counterclockwise directions. In some embodiments, as shown in FIG. 5, the push handles 38, 40 may include an adjustable knob 140 that can be configured to prevent the rotation of the gripping region 120. The amount of force required to be exerted on the gripping region 120 to rotate the gripping region about the first generally angled or bent portion 122 can be adjusted by adjusting the adjustable knob 140.

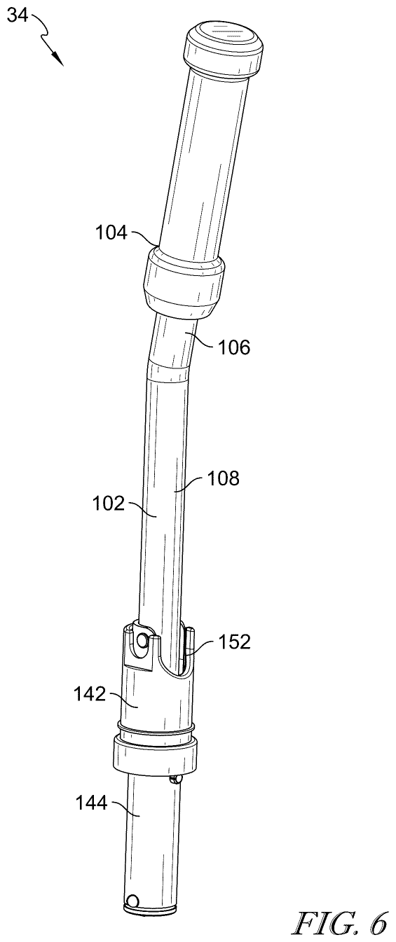

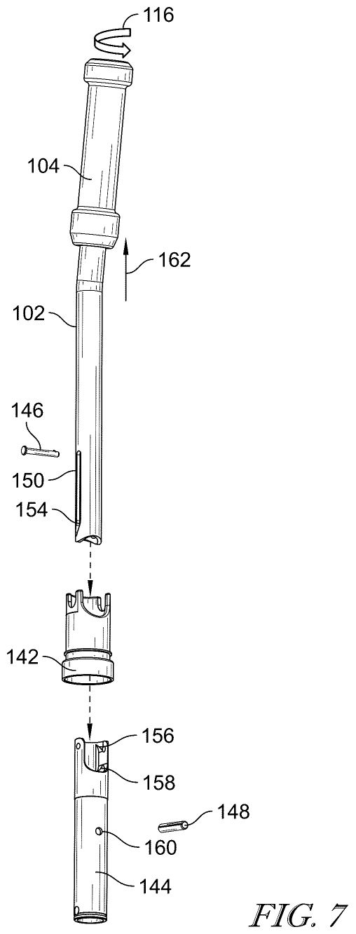

Referring to FIGS. 6 and 7, the push handle 34 or 36 illustrated in FIG. 3, includes a base shroud 142 which overlies a stem 144 which engages the upper frame 18. The handle tube 102 is received internally in the stem 144 and a pin 146 passes through an elongated slot 150 on the handle tube 102 to secure the handle tube 102 to the stem 144. The base shroud 142 includes a relief 152 which accommodates the base of the handle tube 102 when the push handle 34 is folded over to a storage position. In use, the push handle 34 is inserted such that a base 154 of the handle tube 102 is seated in the inner diameter 156 of the stem 144. To stow the push handle 34 the user pulls the push handle upwardly in the direction of arrow 162 such that it clears the relief 152 of the base shroud 142 and a relief 158 of the stem 144. The push handle 34 is then capable of being laid down to a stowed position. A bolt 148 inserted into a slot 160 on the stem 144 prevents vertical movement of the handle tube 102 below the position of the slot 160 on the stem 144. The gripping region 104 is not attached to the handle tube 102 with any screws, pins, or bolts, thereby allowing the gripping region to be rotatable around the push handle in the direction 116. The gripping region 104 may be elongated to allow for a larger variation in height of a user providing an improved ergonomic structure for persons who utilize the transport handles on the patient support apparatus 10.

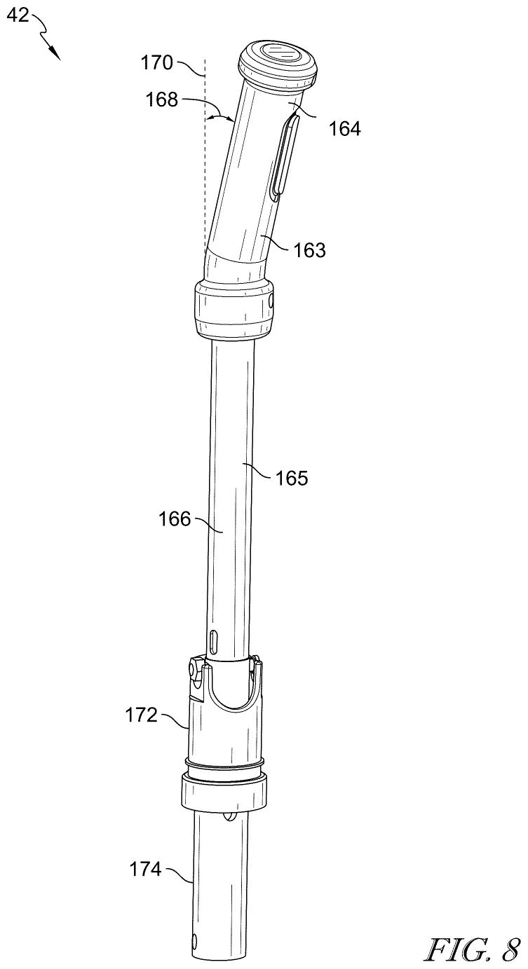

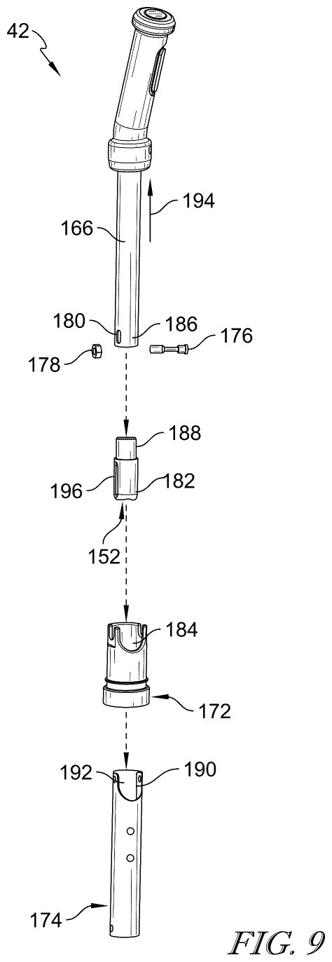

FIGS. 8 and 9 illustrates another embodiment of a push handle 42. The push handle 42 includes a handle tube 166 and a gripping region 164. The handle tube 166 may be a hollow structure or a solid structure. The handle tube 166 comprises a generally angled or bent portion 163 and a generally straight portion 165. The generally angled or bent portion 163 is inserted into the gripping region 164. The generally angled or bent portion 163 may be positioned at an angle 168 relative to a vertical axis 170. The angle 168 may range from about 3 degrees to about 40 degrees relative to the vertical axis 170, including any angle or range comprised therein. The angle 168 may range from about 3 degrees to about 5 degrees, about 5 degrees to about 10 degrees, about 10 degrees to about 15 degrees, about 15 degrees to about 20 degrees, about 20 degrees to about 25 degrees, about 25 degrees to about 30 degrees, about 30 degrees to about 35 degrees, or about 35 degrees to about 40 degrees. The angle 168 increases the ergonomic use of the handle 42. The generally straight portion 165 of the handle tube 166 is connected to the upper frame 18.

Referring to FIG. 9, the push handle 42 includes a base shroud 172 which overlies a stem 174 which engages the upper frame 18. The handle tube 166 is received internally in the stem 174 and a pin 176 passes through a slot 180 of the handle tube 166 to secure the handle tube 166 to the stem 174. The pin 176 is secured with a nut 178. The pin 176 also secures a socket 182 at a slot 196 to the stem 174. The base 186 of the handle tube 166 engages the socket 182 at projection 188. The base shroud 172 includes a relief 184, which accommodates the base of the handle tube 166 when the push handle 42 is folded over to a storage position. In use, the push handle 42 is inserted such that the base 186 is seated over the outer diameter of the projection 188 of the socket 182. The socket 182 sits in the inner diameter 190 of the stem 174. To stow the push handle 42 the user pulls the push handle upwardly in the direction of arrow 194 such that it clears the relief 184 of the base shroud 172 and a relief 192 of the stem 174. The push handle 42 is then capable of being laid down to a stowed position. The gripping region 164 may be elongated to allow for a larger variation in height of a user providing an improved ergonomic structure for persons who utilize the transport handles on the patient support apparatus 10.

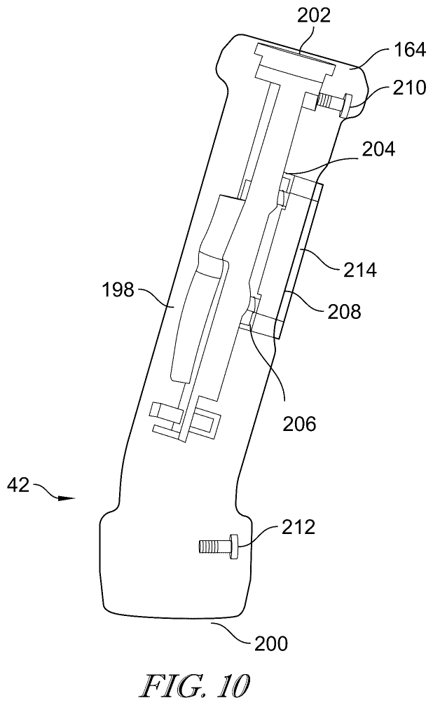

Referring to FIG. 10, the gripping region 164 of the push handle 42 comprises a sleeve 198 with a slot 200. The handle tube 166 is inserted into the slot 200. The gripping region 164 includes a knob 214 connected to a plate 202 by springs 204, 206. The knob 214 is accessible to the user through a slot 208. The plate 202 is attached to the sleeve 198 by a screw 210 and the sleeve 198 is attached to the handle tube 102 by a screw 212. In such embodiments, a generally angled or bent portion 163 of the handle tube 166 is inserted into the gripping region 164, but the gripping region 164 is not completely rotatable around the handle tube 166.

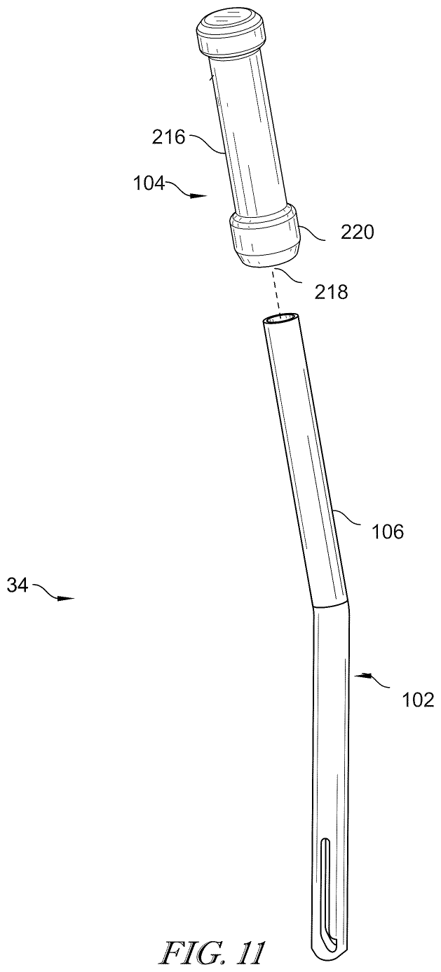

Referring to FIG. 11, the gripping region 104 of the push handles 34 comprises a sleeve 216 with a slot 218. The handle tube 102 is inserted into the slot 218. In such embodiments, a generally angled or bent portion 106 of the handle tube 102 is inserted into the gripping region 104, but the gripping region 104 is not attached to the handle tube 102 by any knob or screw or other attachment. The gripping region 104 is completely rotatable around the handle tube 102. The gripping region 104 maybe attached to the handle tube 102 by a connector system 220 including but not limited to common shaft retaining methods such as a shaft collar 220 so that the gripping region 104 is configured to rotate about the generally angled or bent portion 106 of the handle tube 102.

Although this disclosure refers to specific embodiments, the disclosure is not limited to the disclosed embodiments. It will be understood by those skilled in the art that various changes in form and detail can be made without departing from the subject matter set forth in the accompanying claims. For example, the disclosure has been illustrated and described in detail in the drawings and the foregoing description, such illustration and description are to be considered illustrative or exemplary and not restrictive. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

1. A patient support apparatus comprising:
a patient support deck positioned on an upper frame and including a head deck section, a seat deck section, and a foot deck section supported on the upper frame,
a plurality of casters connected with a lower frame, and
a plurality of push handles coupled to at least one of the upper frame and the lower frame, each of the plurality of push handles comprising a gripping portion and a handle tube, wherein the handle tube is attached to the upper frame and configured to include a first angled portion and a second vertical portion, and
wherein the gripping portion is configured to be rotatable about a first axis parallel to the first angled portion of the handle tube, and wherein the gripping portion is positioned at an angle of about 5 degrees to 40 degrees relative to a second axis parallel to the second vertical portion of the handle tube.

2. The patient support apparatus of claim 1, wherein the gripping portion is fastened to the handle tube with an adjustable knob.

3. The patient support apparatus of claim 2, wherein the gripping portion is configured to be lockable to the handle tube with the adjustable knob, and wherein the gripping portion cannot be rotated about the first axis when locked.

4. The patient support apparatus of claim 2, wherein the adjustable knob is configured to control rotation of the gripping portion about the first axis.

5. The patient support apparatus of claim 1, wherein the gripping portion is configured to be rotatable 360 degrees about the first axis.

6. The patient support apparatus of claim 1, wherein the second vertical portion of the handle tube is attached to the upper frame by an insert attachment.

7. The patient support apparatus of claim 1, wherein the gripping portion of a first push handle is configured to be rotatable in the same direction as the gripping portion of a second push handle.

8. The patient support apparatus of claim 1, wherein the gripping portion of a first push handle is configured to be rotatable in a different direction than the gripping portion of a second push handle.

9. The patient support apparatus of claim 1, wherein the handle tube further comprises a third portion, wherein the third portion of the handle tube is a third angled portion positioned in between the first angled portion and the second vertical portion.

10. A method of moving a patient support apparatus comprising:
applying a torque on a gripping portion of a push handle located on the patient support apparatus, the push handle comprising the gripping portion and a handle tube, and
transferring the torque applied on the push handle to an insert attachment, the insert attachment configured to engage with an upper frame of the patient support apparatus and rotate a plurality of casters for transport of the patient support apparatus,
wherein the gripping portion is configured to be rotatable about an axis parallel to a first angled portion of the handle tube.

11. The method of claim 10, wherein the gripping portion is positioned at an angle of about 5 degrees to 40 degrees relative to a second axis parallel to a second vertical portion of the handle tube.

12. The method of claim 10, the method comprises adjusting the gripping portion by moving an adjustable knob, wherein the gripping portion is configured to be lockable to the handle tube with the adjustable knob.

13. The method of claim 12, wherein the adjustable knob is configured to control rotation of the gripping portion about the axis parallel to the first angled portion of the handle tube.

14. The method of claim 10, wherein the gripping portion is configured to be rotatable 360 degrees about the axis parallel to the first angled portion of the handle tube.

15. The method of claim 10, wherein the patient support apparatus comprises a first push handle and a second push handle, and wherein the gripping portion of the first push handle is configured to be rotatable in the same direction as the gripping portion of the second push handle.

16. The method of claim 10, wherein the patient support apparatus comprises a first push handle and a second push handle, and wherein the gripping portion of the first push handle is configured to be rotatable in a different direction than the gripping portion of the second push handle.

17. A patient support apparatus comprising:
a patient support deck configured to support a patient mattress;
an upper frame supporting the patient support deck;
a lower frame, wherein the upper frame is movable relative to the lower frame;
a plurality of casters connected with the lower frame; and
a plurality of push handles connected with at least one of the lower frame and the upper frame, wherein the plurality of push handles are configured to allow a caregiver to push the patient support apparatus and thereby rotate the plurality of casters for transport of the patient support apparatus, wherein each of the plurality of push handles comprises a generally vertical portion and an angled portion extending at an angle relative to the generally vertical portion, and wherein the plurality of push handles further comprise a gripping portion configured to rotate about the angled portion when the caregiver is pushing and turning the patient support apparatus.

18. The patient support apparatus of claim 17, wherein each of the plurality of push handles comprises a connectors system configured to position the gripping portion on the angled portion and allow the gripping portion to rotate about the angled portion.

19. The patient support apparatus of claim 17, wherein an amount of force required to control rotation of the gripping portion about the angled portion can be adjusted by adjusting the adjustable knob.

20. The patient support apparatus of claim 17, wherein the gripping portion is configured to be rotatable 360 degrees about an axis parallel to the angled portion.
